(19) United States
(12) Patent Application Publication
(10) Pub. No.: US 2005/0108192 A1
(43) Pub. Date: May 19, 2005

(54) Tree structure

(76) Inventor: Hua Huang, Fremont, CA (US)

Correspondence Address: PATENT LAW GROUP LLP, 2635 NORTH FIRST STREET, SUITE 223, SAN JOSE, CA, 95134, US

(21) Appl. No.: 10/717,853

(22) Filed: Nov. 18, 2003

(51) Int. Cl. G06F 7/00

(52) U.S. Cl. 707/1

(57) ABSTRACT

A data structure includes a parent node and a plurality of children nodes of the parent node arranged in an order. The parent node includes a first pointer to one of the children nodes and a second pointer to another of the children nodes. Each child node includes a third pointer to a next child node in the order and a fourth pointer to a previous child node in the order. The parent node can further include a fifth pointer to a child node that was last queried.

### FIELD OF INVENTION

This invention relates to a tree structure for storing data.

### DESCRIPTION OF RELATED ART

FIG. 1 illustrates a conventional N-tree structure 10 for storing an N-dimensional object. Root 12 of tree structure 10 corresponds to the entire object. If the object is completely uniform (i.e., all the data are the same), then its data are stored in root 12 and root 12 becomes the entire tree. Otherwise, a new level is added to tree structure 10 with nodes 14-0, 14-1 . . . 14-N that correspond to subdivisions of the object. If a subdivision is completely uniform, such as node 14-N, then its data are stored in its node and the node becomes a leaf of tree structure 12. A non-uniform subdivision adds a new level to tree structure 12, with child nodes 16-0, 16-1 . . . 16-N that correspond to sub-subdivisions of the non-uniform subdivision. This structure continues until the smallest unit of the object is reached so the object cannot be further divided.

As FIG. 1 illustrates, each node must have N pointers to its child node. If N is a large number, then tree structure 10 consume a large amount of memory just to store the pointers. Thus, what is needed is a more efficient tree structure.

### BRIEF DESCRIPTION OF THE DRAWINGS

FIG. 1 illustrates a conventional N-tree structure.

FIG. 2 illustrates a tree structure in one embodiment of the invention.

FIG. 3 illustrates a node of the tree structure of FIG. 2 in one embodiment of the invention.

FIG. 4 illustrates a method to search the tree structure of FIG. 2 in one embodiment of the invention.

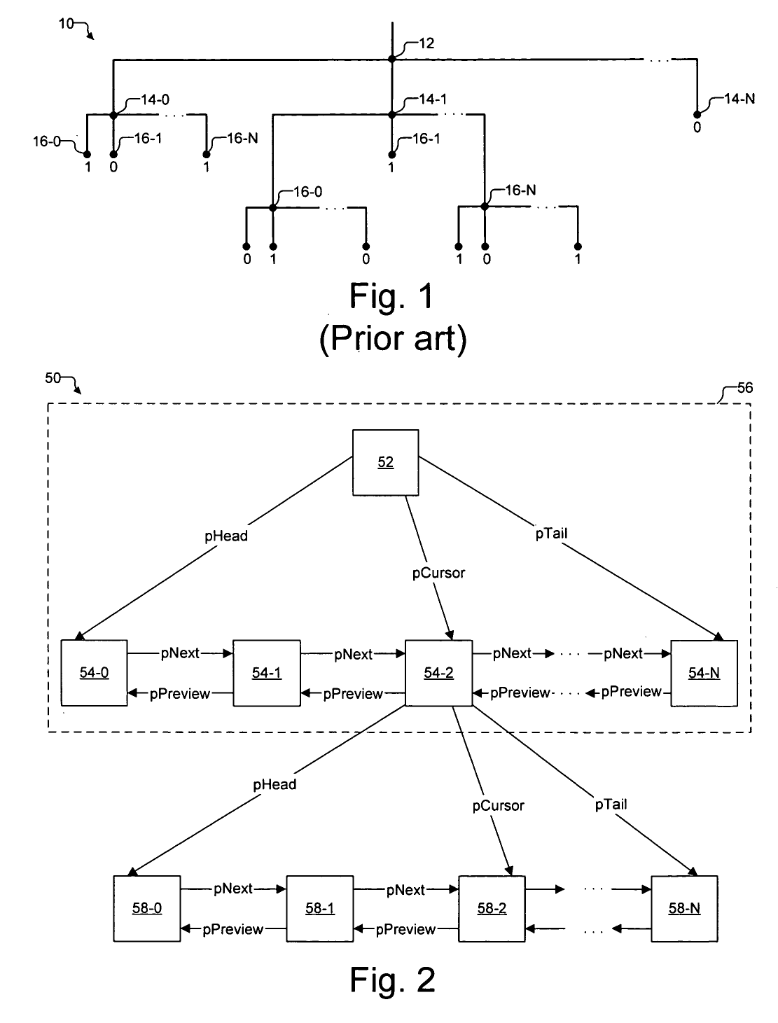

Use of the same reference numbers in different figures indicates similar or identical elements.

### SUMMARY

In one embodiment of the invention, a data structure includes a parent node and a plurality of children nodes of the parent node arranged in an order. The parent node includes a first pointer to one of the children nodes and a second pointer to another of the children nodes. Each child node includes a third pointer to a next child node in the order and a fourth pointer to a previous child node in the order. The parent node can further include a fifth pointer to a child node that was last queried.

### DETAILED DESCRIPTION

FIG. 2 illustrates a data structure 50 for storing an object, such as an image, in one embodiment of the invention. Data structure 50 starts with a root node 52 that represents the entire object. Root node 52 is linked by pointers pHead, pTail, and pCursor to the next level of nodes 54-0, 54-1, 54-2 . . . 54-N. Nodes 54-0 to 54-N correspond to subdivisions of the object in a predetermined order. In one embodiment, pointer pHead points from a parent node, such as root node 52, to a specific child node in the predetermined order, such as the first child node 54-0. In one embodiment, pointer pTail points from a parent node, such as root node 52, to another specific child node in the predetermined order, such as the last child node 54-N. In one embodiment, pointer pCursor points from a parent node, such as root node 52, to a child node that was last queried in a search.

Each of nodes 54-0 to 54-N is linked by pointers pNext and pPreview to two other nodes in the same level. In one embodiment, pointer pNext points from a node, such as node 54-1, to the next node in the predetermined order, such as node 54-2. In one embodiment, pointer pPreview points from a node, such as node 54-1, to the previous node in the predetermined order, such as node 54-0.

The above described structure 56 is the basic substructure of data structure 50 and can be repeated to represent the object in ever finer detail. For example, each of nodes 54-0 to 54-N can be linked by pointers pHead, pTail, and pCursor to the next level of children nodes 58-0, 58-1, 58-2 . . . 58-N as described above. Each of nodes 58-0 to 58-N can be linked by pointers pNext and pPreview to two other nodes in the same level.

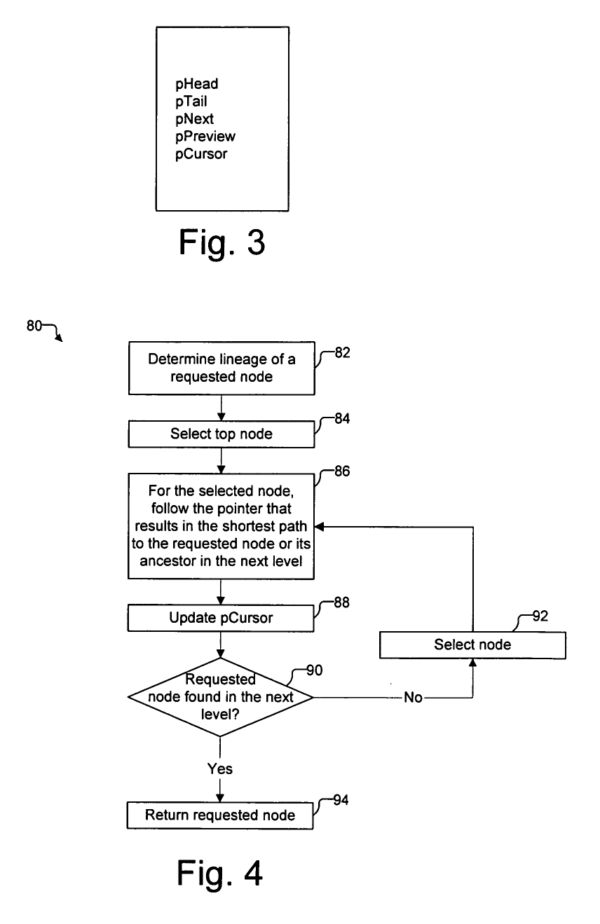

FIG. 3 illustrates the pointers stored in a node in data structure 50. Specifically, each node stores pointers pHead, pTail, pNext, pPreview, and pCursor, which are used to search for nodes as described above and hereafter.

FIG. 4 is a flowchart of a method 80 for searching a requested node in data structure 50 (FIG. 2) in one embodiment of the invention.

In step 82, the lineage of the requested node is determined. For example, if the requested node is node 58-2, then the lineage of node 58-2 includes a parent node 54-2 and a grandparent node 52. The lineage of the requested node can be determined by the predetermined order in which the object is divided into nodes.

In step 84, root node 52 of data structure 50 (FIG. 2) is selected.

In step 86, the shortest path from the selected node through the next level to the requested node is determined. Specifically, the paths from pointers pHead, pTail, and pCursor of the selected node are compared to determine the shortest path to the requested node if it is located in the next level, or one of the ancestor nodes of the requested node if the requested node is not located in the next level.

In most applications, nodes are requested in order (forward or backward). For example, nodes 54-0 to 54-N are requested in order. Thus, the quickest path to the requested node results from following pointer pCursor of root node 52 to the last requested node, and then following pointer pNext or pPreview to the currently requested node. In another example, nodes 58-0 to 58-N are requested in order. Thus, the quickest path to the requested node most often results in following pointer pCursor of root node 52 to node 54-2, then following pointer pCursor of node 54-2 to the last requested node, and then following pointer pNext or pPreview to the currently requested node. Thus, the quickest path most often results from following pointers pCursor to the level of the currently requested node, and then following pointer pNext or pPreview to the currently requested node.

In step 88, pointer pCursor for the selected node is updated to point to the requested node or its ancestor in the next level.

In step 90, it is determined if the requested node or its ancestor node has been found in the next level. If the requested node has been found, then step 90 is followed by step 94. If its ancestor node has been found, then step 90 is followed by step 92.

In step 92, the ancestor node is selected. Step 92 is followed by step 86 and again the shortest path from the selected node through the next level to the requested node is determined. These steps are repeated until the requested node has been found.

In step 94, the requested node is returned in response to the request and ends method 80.

Various other adaptations and combinations of features of the embodiments disclosed are within the scope of the invention. Numerous embodiments are encompassed by the following claims.

1. A data structure, comprising a parent node and a plurality of children nodes of the parent node arranged in an order, wherein:
the parent node comprises:
a first pointer to a child node that was last queried;
each child node comprises:
a second pointer to a next child node in the order; and
a third pointer to a previous child node in the order.

2. The data structure of claim 1, wherein the parent node further comprises a fourth pointer to a first child node in the order and a fifth pointer to a last child node in the order.

3. A data structure, comprising a parent node and a plurality of children nodes of the parent node arranged in an order, wherein:
the parent node comprises:
a first pointer to one the children nodes; and
a second pointer to another one of the children nodes;
each child node comprises:
a third pointer to a next child node in the order; and
a fourth pointer to a previous child node in the order.

4. The data structure of claim 1, wherein the parent node further comprises a fifth node to a child node that was last queried.

5. The method of claim 5, wherein the first pointer points to a first child node in the order and the second pointer points to a last child node in the order.

6. A method for generating a data structure comprising a parent node and a plurality of children nodes of the parent node, the method comprising:
creating the parent node with:
a first pointer to one of the children nodes; and
a second pointer to another one of the children nodes;
creating each child node with:
a third pointer to a next child node in the order; and
a fourth pointer to a previous child node in the order.

7. The method of claim 6, further comprising creating the parent node with a fifth pointer to a child node that was last queried.

8. The method of claim 6, wherein the first pointer points to a first child node in the order and the second pointer points to a last child node in the order.

9. A method for querying a data structure comprising a parent node and a plurality of children nodes of the parent node in an order, comprising:
following a first pointer in the parent node to one of the children nodes; and
following a second pointer in said one of the children nodes to another one of the children nodes.

10. The method of claim 9, wherein the first pointer points to a first child node in the order.

11. The method of claim 9, wherein the first pointer points to a last child node in the order.

12. The method of claim 9, wherein the second pointer points to a next child node in the order.

13. The method of claim 9, wherein the second pointer points to the previous child node in the order.

14. The method of claim 9, wherein the first pointer points to a child node last queried.

15. The method of claim 14, further comprising updating the first pointer to point the child node last queried.
